(19) United States
(12) Patent Application Publication
(10) Pub. No.: US 2012/0017074 A1
(43) Pub. Date: Jan. 19, 2012

(54) DYNAMIC SYSTEM MODE SWITCHING

(75) Inventor: Marcus A. Kelly, Bellevue, WA (US)

(73) Assignee: INTERNATIONAL BUSINESS MACHINES CORPORATION, Armonk, NY (US)

(21) Appl. No.: 12/837,979

(22) Filed: Jul. 16, 2010

(51) Int. Cl. G06F 9/50; G06F 9/00

(52) U.S. Cl. 713/100; 718/104

(57) ABSTRACT

A system and method of controlling the system mode of a computer. The method comprises sending an Intelligent Platform Management Interface (IPMI) command to a baseboard management controller (BMC), wherein the IPMI command provides a system mode instruction to the BMC. The BMC then sends an operating parameter instruction to a plurality of hardware devices within the computer in response to receiving the IPMI command, wherein the operating parameter instruction sent to the plurality of hardware devices is associated with the system mode. Accordingly, each of the hardware devices operates according to the operating parameter instruction received from the BMC. Preferably, such a method allows the system mode to be changed without shutting down an operating system or rebooting the computer system. Optionally, the BMC may communicate with the hardware devices over an Inter Integrated Circuit (I2C) bus, a General Purpose Input Output (GPIO) pin of the BMC, or a combination thereof.

### BACKGROUND

1. Field of the Invention

The present invention relates to methods of changing the system mode that is implemented in a computer system.

2. Background of the Related Art

Computer systems, such as servers, can be put into one of several system modes in order to impose limits on performance of the computer system. Although the use of system modes is a useful tool, changing the system mode of a given computer system requires an IT administrator to shut down a running operating system and open a UEFI/BIOS interface (Unified Extensible Firmware Interface/Basic Input Output System interface). By manually accessing the UEFI/BIOS configuration menu, the IT administrator can modify the system mode, for example, from Acoustic, to Efficiency/Default, or to Performance Mode. Due to the UEFI firmware needing to modify device thresholds, device throttle configuration, and device refresh rates for several system hardware devices, such as DIMMs and CPUs, the user interface for system mode configuration is located in the UEFI Power On Self Test (POST) menus. This dependence on UEFI Graphical User Interface (GUI) and current firmware architecture requires the IT administrator to stop the operating system that is running on the computer system, such as a server, before being able to manually change the System Mode for that server. This fact causes servers to be offline whenever the IT administrator wants to modify the power consumption versus performance characteristics of the server.

Furthermore, it is the IT administrator that must decide what system mode (Acoustic, Efficiency/Default, Performance and Custom Mode) each server should be in. Because this determination is made by the IT administrator, many servers are not efficiently utilizing their resources in certain computing environments due to administrator error in selecting an appropriate system mode for those servers. Administrators often assign a given system mode to a server without doing appropriate research and analysis on performance versus power consumption.

### BRIEF SUMMARY

One embodiment of the present invention provides a method of controlling the system mode of a computer. The method comprises sending an Intelligent Platform Management Interface (IPMI) command to a baseboard management controller (BMC), wherein the IPMI command provides a system mode instruction to the BMC. The BMC then sends an operating parameter instruction to a plurality of hardware devices within the computer in response to receiving the IPMI command, wherein the operating parameter instruction sent to the plurality of hardware devices is associated with the system mode. Accordingly, each of the plurality of hardware devices operates according to the operating parameter instruction received from the BMC.

Another embodiment of the present invention provides a computer program product including computer usable program code embodied on a computer usable storage medium for controlling the system mode of a computer.

Yet another embodiment of the present invention provides a computer system, comprising a motherboard including a BMC communicating operating parameter instructions over an Inter Integrated Circuit (I2C) bus with a plurality of hardware devices of the computer system. Optionally, the BMC may also have one or more general purpose input output pins for communicating operating parameter instructions to one or more hardware devices of the computer system.

### BRIEF DESCRIPTION OF THE SEVERAL VIEWS OF THE DRAWINGS

FIG. 1 is a block diagram of a method of controlling the system mode of a computer.

FIG. 2 is a block diagram of a method of dynamically controlling the system mode of a computer using a schedule.

FIG. 3 is a block diagram of a method of automatically controlling the system mode of a computer in response to system resource usage.

### DETAILED DESCRIPTION

One embodiment of the present invention provides a method of controlling the system mode of a computer. The method comprises sending an Intelligent Platform Management Interface (IPMI) command to a baseboard management controller (BMC), wherein the IPMI command provides a system mode instruction to the BMC. The BMC then sends an operating parameter instruction to a plurality of hardware devices within the computer in response to receiving the IPMI command, wherein the operating parameter instruction sent to the plurality of hardware devices is associated with the system mode. Accordingly, each of the plurality of hardware devices operates according to the operating parameter instruction received from the BMC. Preferably, such a method allows the system mode to be changed without shutting down an operating system (OS) or rebooting the computer system.

The BMC may communicate with the plurality of hardware devices over an Inter Integrated Circuit (I2C) bus, a General Purpose Input Output (GPIO) pin of the BMC, or a combination thereof. For example, the BMC may communicate with a fan controller and front panel lights over GPIO pins and communicate with a processor and memory over an I2C bus.

In one embodiment, IPMI commands are used instruct the BMC to modify or change the system mode of the computer system. For example, the system mode may be selected from Acoustic, Performance, and Default/Efficiency. Additional system modes may be defined and implemented as needed. Optionally, the BMC may also provide a signal to a front panel light path LED indicating the system mode of the computer system. For example, a server may have a front panel with red, green and yellow lights, wherein the red light indicates Performance Mode, the green light indicates Default/Efficiency Mode, and the yellow light indicates Acoustic Mode.

In a further embodiment, the method establishes a schedule of changes in the system mode of the computer, wherein the step of sending an IPMI command to the BMC is automatically performed according to the schedule. For example, a user may configure a system mode schedule in a standard IPMI, such as an Integrated Management Module (IMM) web interface or IBM Director Console, so that special IPMI commands are sent to the BMC at predetermined times for the purpose of modifying the system mode. The BMC receives the new IPMI commands and modifies the corresponding operating parameters of various hardware devices. These operating parameters may be, for example, thermal threshold values, refresh rates, dynamic p-state configuration and fan speed algorithm for a given system mode.

In a still further embodiment, the method establishes a usage setpoint for one or more system resource of the computer, wherein the usage setpoint is associated with a change in the system mode of the computer. System resources within the computer are monitored, and an IPMI command is automatically sent to a baseboard management controller in response to the system resource usage reaching the usage setpoint. For example, a client side tool, such as an add-on to Active Energy Manager client or Director client, can monitor resource utilization and send IPMI commands to the BMC. It is preferable that such automatic system mode switching would allow servers to automatically switch to a system mode that is best suited for the real time resource utilization of a given server. Optionally, a user is allowed to enable and disable automatic sending of an IPMI command, such as through a graphical user interface of the client side tool.

The plurality of hardware devices includes all system hardware devices that are responsible for modifying the system mode. For example, the plurality of hardware devices may include one or more of a fan controller, processor, and memory controller. Similarly, the operating parameter instruction includes an operating parameter selected from a fan control algorithm and tables; DIMM, CPU, IOH, & scalability device thermal threshold values; CPU T control offset; memory refresh rate; CPU P-state dynamic transition configuration, such as Enhanced Intel Speedstep Technology (EIST) P-state de-rating; CPU auto halt (C1E State); and CPU Turbo Mode Configuration; Quickpath Interface (QPI) link speed modification (which may require reboot for activation); and combinations thereof.

Another embodiment of the present invention provides a computer program product including computer usable program code embodied on a computer usable storage medium for controlling the system mode of a computer. Accordingly, the computer program product may performed or initiate the performance of the steps in any of the foregoing methods. Computer usable program code for scheduling IPMI system mode commands or automatically sending IPMI system mode commands in response to system resource usage is preferably included in a client tool. Computer usable program code for sending operating parameter instructions to the hardware devices is preferably executed by the BMC firmware.

Yet another embodiment of the present invention provides a computer system, comprising a motherboard including a BMC communicating operating parameter instructions over an I2C bus with a plurality of hardware devices of the computer system. Optionally, the baseboard management controller may also have one or more general purpose input output pins for communicating operating parameter instructions to one or more hardware devices of the computer system.

Embodiments of the present invention for changing the system mode are compatible with existing UEFI/BIOS methods for changing the system mode and it is not necessary to remove the existing UEFI/BIOS interfaces. In fact, the GUI for UEFI can send an IPMI command with a system mode instruction to the BMC. However, since the UEFI GUI is only accessible when the operating system is stopped, it is preferably to use the client side tools described above for sending the IPMI command to the BMC.

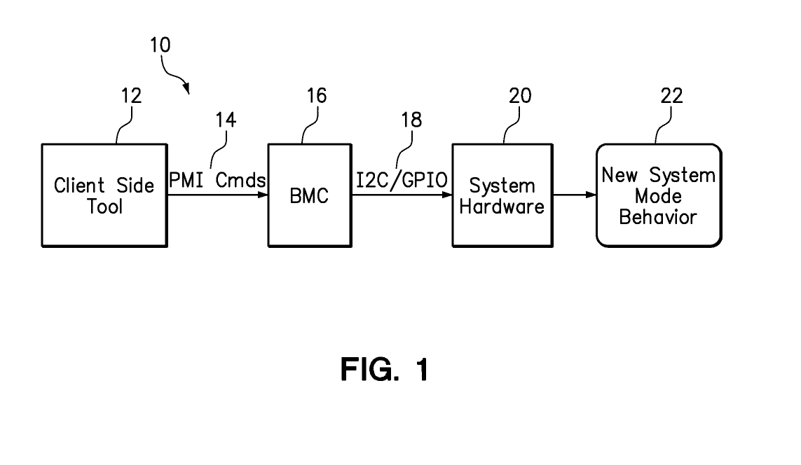

FIG. 1 is a block diagram of a method 10 of controlling the system mode of a computer. A client side tool 12 is used to send IPMI commands 14 to a BMC 16. The IPMI commands instruct BMC to put the computer in a given system mode, whether the IPMI commands are manually entered by an IT administrator, previously scheduled, or automatically generated in response to computer resource utilization. The BMC 16 then sends operating parameter instructions to system hardware devices 20 that are affected by the modified system mode. For example, such operating parameter instructions may be communicated over an I2C bus or GPIO pins 18. The result of these actions is that the computer operates in accordance with the new/updated system mode, as represented in block 22.

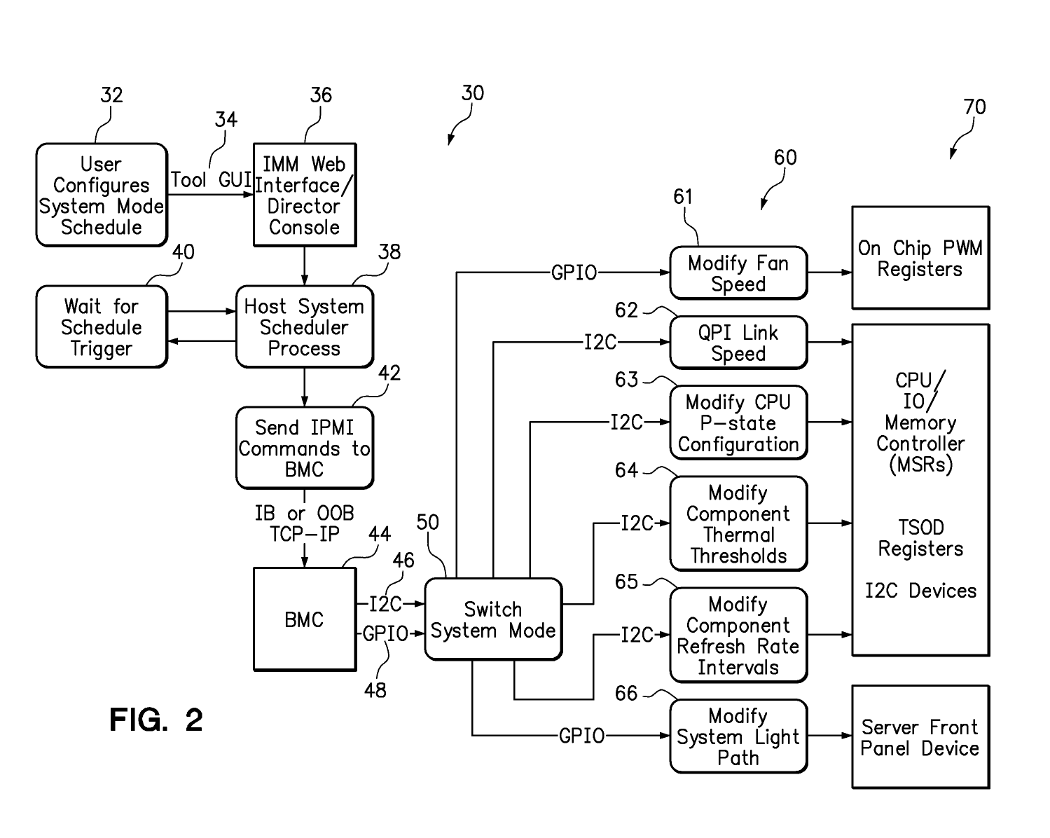

FIG. 2 is a block diagram of a method 30 of dynamically controlling the system mode of a computer using a schedule. A user configures a system mode schedule, per step 32, using the graphical user interface 34 of a client tool 36, which may be an IMM web interface or IBM Director Console. The client tool 36 includes or interfaces with a host system scheduler process 38 that waits for a schedule trigger per step 40. When a schedule trigger is detected, such as the time reaching a schedule time value, then an IPMI command is sent, in step 42, to the BMC 44. The IPMI command may be sent in-band (IB), such as over a serial/kcs channel, or out-of-band (OOB), such as using TCP-IP protocol on a WAN/LAN channel.

In response to receiving the IPMI command, the BMC 44 implements the system mode (as illustrated at block 50) by sending operating parameter instructions 60 over an I2C bus 46 or used GPIO pins 48 to a plurality of hardware devices 70 that are responsible for effecting the new system mode. A separate operating parameter instruction is provided to each of the effected hardware devices 70. For example, an operating parameter instruction 61 may be sent over a GPIO pin to certain on-chip PWM registers in order to modify the fan speed; an operating parameter instruction 62 may be sent over the I2C bus to a processor to modify the QuickPath Interconnect (QPI) link speed; an operating parameter instruction 63 may be sent over the I2C bus to a processor to modify the CPU power state configuration; an operating parameter instruction 64 may be sent over the I2C bus to various heat-generating components to modify the component thermal threshold; an operating parameter instruction 65 may be sent over the I2C bus to a memory controller to modify the memory refresh rate intervals; and an operating parameter instruction 66 may be sent over a GPIO pin to a server front panel device in order to modify the system light path. It should be recognized that the messages, hardware devices, and types of interconnections are non-limiting examples, and that other messages, hardware devices, and types of interconnections may be used in accordance with the invention.

The BMC firmware is preferably burned with all supported system mode configuration parameters. For example, for each support system mode that the BMC may be instructed to implement, the BMC firmware would have a listing of associated operating parameters. Optionally, an operating parameter such as the CPU temperature control threshold value may be different in each system mode, such as a Acoustic, Default and Performance Mode. Accordingly, each time the BMC receives a new system mode instruction, the BMC would then send out a new operating parameter instruction to the CPU (i.e., the associated CPU temperature control threshold value) and new operating parameter instructions to other hardware devices according to the system mode configuration parameters stored in the BMC firmware. To support custom system modes, the IPMI command can send additional request bytes that include a user-specified value of an operating parameter for a given hardware device.

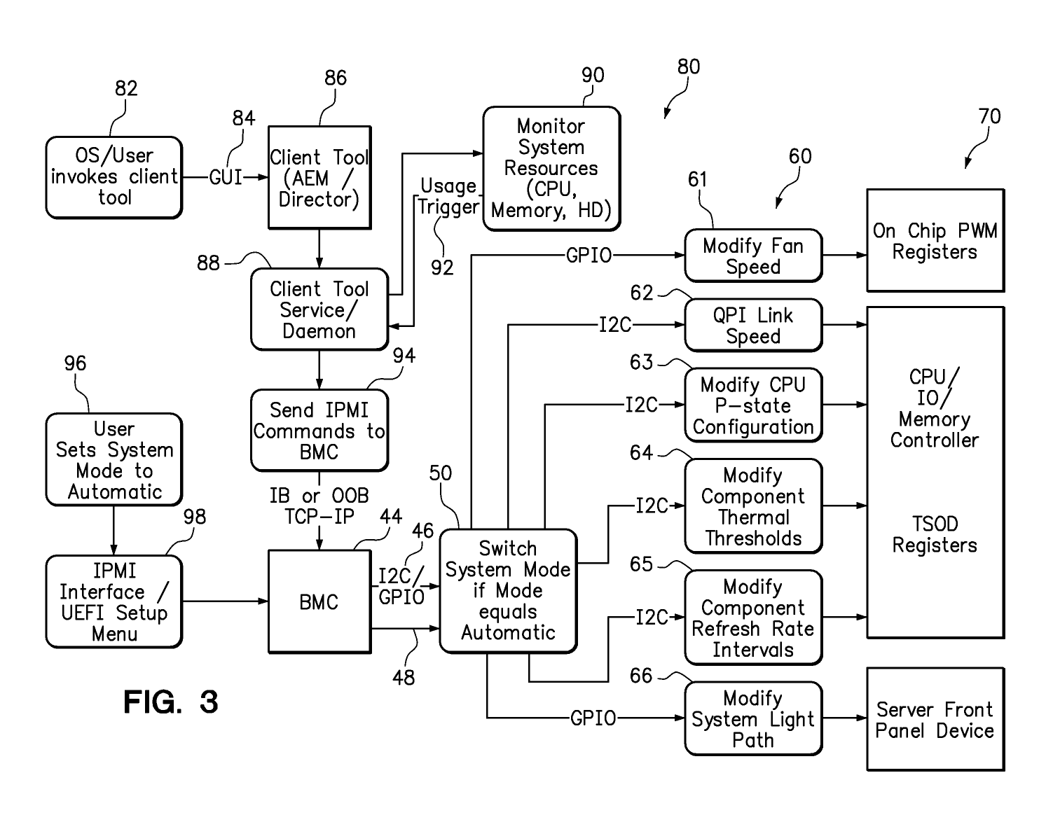

FIG. 3 is a block diagram of a method 80 of automatically controlling the system mode of a computer in response to system resource usage. Elements of FIG. 3 that are similar to those of FIG. 2 are labeled with the same reference numbers and the description of those elements in relation to FIG. 2 is equally applicable in relation to FIG. 3. The differences between FIG. 2 and FIG. 3 are directed to the method of automatically generating the IPMI command that is sent to the BMC 44.

In step 82, a user or operating system (OS) will invoke a client tool 86. For example, a user may interact with a graphical user interface (GUI) 84 of the client tool 86. A service or daemon 88 of the client tool 86 monitors system resources, such as the processor, memory and a hard disk drive, in block 90. When a usage trigger 92 is received, for example upon a system resource exceeding a setpoint usage level, step 94 sends an IPMI command to the BMC 44. Optionally, the particular IPMI command will instruction the BMC to implement a system mode that will more closely match the current usage of one or more of the system resources. The BMC 44 may then send an operating parameter instruction to each of various hardware devices 70, as described previously in relation to FIG. 2.

In a further optional aspect of the invention, a user may set up the client tool and/or the BMC to enable or disable automatic modification of the system mode, as shown in block 96. The user may do so, for example, using the IPMI interface/UEFI setup menu to communicate with the BMC 44.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of controlling the system mode of a computer, comprising:
sending an Intelligent Platform Management Interface command to a baseboard management controller, wherein the Intelligent Platform Management Interface command provides a system mode instruction to the baseboard management controller;
the baseboard management controller sending an operating parameter instruction to a plurality of hardware devices within the computer in response to receiving the Intelligent Platform Management Interface command, wherein the operating parameter instruction sent to the plurality of hardware devices is associated with the system mode; and
each of the plurality of hardware devices operating according the operating parameter instruction received from the baseboard management controller.

2. The method of claim 1, wherein the baseboard management controller communicates with the plurality of hardware devices over an Inter Integrated Circuit bus.

3. The method of claim 1, wherein the baseboard management controller communicates with the plurality of hardware devices over a General Purpose Input Output pin of the baseboard management controller.

4. The method of claim 1, further comprising:
establishing a schedule of changes in the system mode of the computer, wherein the step of sending an Intelligent Platform Management Interface command to a baseboard management controller is automatically performed according to the schedule.

5. The method of claim 1, further comprising:
establishing a usage setpoint for one or more system resource of the computer, wherein the usage setpoint is associated with a change in the system mode of the computer; and
monitoring system resources within the computer, wherein the step of sending an Intelligent Platform Management Interface command to a baseboard management controller is automatically performed in response to the system resource usage reaching the usage setpoint.

6. The method of claim 5, further comprising:
allowing a user to enable and disable automatic sending of an Intelligent Platform Management Interface command.

7. The method of claim 1, wherein the plurality of hardware devices includes one or more of a fan controller, processor, and memory controller.

8. The method of claim 1, wherein the operating parameter instruction includes an operating parameter selected from a fan speed, power state, thermal threshold, refresh rate, and combinations thereof.

9. A computer program product including computer usable program code embodied on a computer usable storage medium, the computer program product comprising:
computer usable program code for sending an Intelligent Platform Management Interface command to a baseboard management controller, wherein the Intelligent Platform Management Interface command provides a system mode instruction to the baseboard management controller; and
computer usable program code for causing the baseboard management controller to send an operating parameter instruction to a plurality of hardware devices within the computer in response to receiving the Intelligent Platform Management Interface command, wherein the operating parameter instruction sent to the plurality of hardware devices is associated with the system mode.

10. The computer program product of claim 9, further comprising:
computer usable program code enabling the baseboard management controller to communicate with the plurality of hardware devices over an Inter Integrated Circuit bus.

11. The computer program product of claim 9, further comprising:
computer usable program code enabling the baseboard management controller to communicate with the plurality of hardware devices over a General Purpose Input Output pin of the baseboard management controller.

12. The computer program product of claim 9, further comprising:
computer usable program code for establishing a schedule of changes in the system mode of the computer; and
computer usable program code for automatically sending an Intelligent Platform Management Interface command to a baseboard management controller according to the schedule.

13. The computer program product of claim 9, further comprising:
computer usable program code for establishing a usage setpoint for one or more system resource of the computer, wherein the usage setpoint is associated with a change in the system mode of the computer; and
computer usable program code for monitoring system resources within the computer; and
computer usable program code for automatically sending an Intelligent Platform Management Interface command to a baseboard management controller in response to the system resource usage reaching the usage setpoint.

14. The computer program product of claim 13, further comprising:
computer usable program code allowing a user to enable and disable automatic sending of an Intelligent Platform Management Interface command.

15. The computer program product of claim 9, wherein the plurality of hardware devices includes one or more of a fan controller, processor, and memory controller.

16. The computer program product of claim 9, wherein the operating parameter instruction includes an operating parameter selected from a fan speed, power state, thermal threshold, refresh rate, and combinations thereof.

17. A computer system, comprising:
a motherboard including a baseboard management controller communicating operating parameter instructions over an Inter Integrated Circuit bus with a plurality of hardware devices of the computer system.

18. The computer system of claim 17, wherein the baseboard management controller has one or more general purpose input output pins for communicating operating parameter instructions to one or more hardware devices of the computer system.
